(19) United States
(12) Patent Application Publication
(10) Pub. No.: US 2002/0122747 A1
(43) Pub. Date: Sep. 5, 2002

(54) Integrated microdevices for conducting chemical operations

(76) Inventors: Mingqi Zhao, Cupertino, CA (US); Hilary S. Lackritz, Cupertino, CA (US); Richard M. Crooks, College Station, TX (US)

Correspondence Address: Richard R. Batt, Morrison & Foerster LLP, 755 Page Mill Road, Palo Alto, CA, 94304-1018, US

(21) Appl. No.: 09/957,579

(22) Filed: Sep. 19, 2001

Related U.S. Application Data
(60) Provisional application No. 60/233,838, filed on Sep. 19, 2000.

(51) Int. Cl. G01N 27/26; G01N 27/447

(52) U.S. Cl. 422/99; 204/451; 204/601

(57) ABSTRACT

A microdevice having integrated components for conducting chemical operations. Depending upon the desired application, the components include electrodes for manipulating charged entities, heaters, electrochemical detectors, sensors for temperature, pH, fluid flow, and the like. The device is fabricated from a plastic substrate that is comprised of a substantially saturated norbornene based polymer. The components are integrated into the device by adhering an electrically conductive film to the substrate. The film is made of metal or ink and is applied to the device through metal deposition or printing.

### CROSS-REFERENCE TO RELATED APPLICATIONS

This application claims priority to U.S. Provisional Application Serial No. 60/233,838, filed Sep. 19, 2000 the contents of which are hereby incorporated by reference into the present disclosure.

### FIELD OF THE INVENTION

The technical field of the invention relates to integrated microdevices for conducting chemical operations.

### BACKGROUND OF THE INVENTION

Miniaturized devices for conducting chemical and biochemical operations have gained widespread acceptance as a new standard for analytical and research purposes. Provided in a variety of sizes, shapes, and configurations, the efficiency of these devices has validated their use in numerous applications. For example, microfluidic lab chips are utilized to conduct capillary electrophoresis and other analytical assays in a reproducible and effective manner. Microarrays or Bio-chips are used to conduct hybridization assays for sequencing and other nucleic acid analysis. Although these devices are currently very functional, they can be made more efficient through the integration of components such as electrodes, heaters, valves and other components.

Due to factors such as convenience, efficiency, and cost, plastics are becoming the material of choice for making these devices. For example, conventional molding techniques can be used to produce large numbers of disposable plastic devices, each having precise and intricate features such as microchannel networks, reservoirs, or microwells. Plastic films can also be efficiently extruded into laminates containing the required microfeatures. Replication of plastic devices can be done with high reproducibility and little variation between different units. A problem however arises in that many plastics applicable to the relative field, are not necessarily metallizable, a property needed for the integration of metal components. For plastics, the energy match between metals and their surfaces is usually incompatible, often leading to delamination. This is particularly true in the case of unreactive noble metals.

There have been a variety of methods used to deposit and pattern metal on the surfaces of plastics or polymers. See, for example, Metallized Plastics I: Fundamental and Applied Aspects, Eds: K. L. Mittal and J. R. Susko, Plenum, 1989. These methods include chemical vapor deposition, electroless deposition, formation of a graded plastic/metal film (so that the plastic/metal bond is not as abrupt and thus not as susceptible to failure), photodecomposition of a liquid-phase metal precursor (e. g., photoreduction), thermal evaporation, sputtering, lithography and the like. In all of these methods, active chemistries present on the surface of the plastic are generally required to avoid delamination of the metallized layer. This is based on the idea that good adhesion requires a strong interaction between the metal and plastic. Methods to enhance this interaction include chemical or physical modification of the plastic surface, i.e. the addition of chemically functional groups or chemical etching. Such surface treatments are often complicated and expensive, result in roughened surfaces that are detrimental to lithographic techniques for patterning the components, or involve the use of facilitative adhesion layers applied to the plastic surface. They also tend to interfere with the intended chemical applications of the device. Further complicating matters is the fact that many plastics or polymers melt at low temperatures or when exposed to organic solvents. This makes them incompatible with the conventional approaches for ink or metal deposition.

To date, many plastics have failed to provide an environment that does interfere with the intended operations of the microdevice yet can still be integrated with strongly adherent metal or electrically conductive components necessary for chemical and biochemical operations, e.g., heating elements, electrodes, valves, flow detectors and the like. Accordingly, there is interest in finding acceptable plastic materials that can be used to fabricate such integrated devices.

### SUMMARY OF THE INVENTION

The present invention is directed towards a microdevice having a norbornene polymer substrate with electrically conductive components incorporated therein. Depending upon the desired application, the components can function in a variety of modes including electrodes for manipulating charged entities, heaters, electrochemical detectors, sensors for temperature, pH, fluid flow, valves, and the like. Accordingly, the device can be used for conducting a various chemical operations including capillary electrophoresis, binding and competitive assays such as oligonucleotide hybridization, polymerase chain reactions, sample preparation, and the like.

In one embodiment, the components are comprised of an electrically conductive film that is strongly adhered to the surface of the substrate. In another embodiment, the components are comprised of electrically conductive ink applied to the substrate surface. Due to the exhibited heat resistance of the norbornene substrate, the incorporated ink and related binders can be processed at temperatures otherwise capable of deforming conventional plastic devices.

### BRIEF DESCRIPTION OF THE FIGURES

FIG. 1 shows an overhead view of a heater integrated into a norbornene based substrate. It includes both the heating element and its incorporated lead.

FIGS. 2a and 2b show a cross sectional view of a microfluidic device having two microchannel systems: one system providing the leads to an electrode and the other system providing for an analytical capillary channel. FIG. 2a shows the unassembled device. FIG. 2b shows the fully assembled device.

FIGS. 3a, 3b, and 3c show cross sectional views of integrated devices with alternative configurations.

FIGS. 4a, 4b, and 4c show a configuration for a microfluidic device with an integrated heater and its functional capabilities. FIG. 4a is a cross sectional view of the device showing the configuration of its integrated heater relative to its microchannels. FIGS. 4b and 4c are graphs of data generated from a device having the configuration shown in FIG. 4a.

FIG. 5 is a schematic showing an overhead view of a microanalysis channel that has both a electrochemical detector and a semi-circular driving electrode integrated therein.

FIG. 6 is a schematic showing an overhead view of a microanalysis channel that has both a heater and a driving electrode integrated therein where the driving electrode has a minimized surface area for reducing unwanted hydrolysis or gas generating reactions.

### DETAILED DESCRIPTION OF THE INVENTION

The present invention is directed to an integrated microdevice for conducting chemical operations. By chemical operations, it is meant analytical and research applications that are by nature, chemical, biochemical, electrochemical, biological, and the like. The device employs one or more functional components strongly adhered to a substrate comprised of a norbornene based polymer. By substrate it is intended the supporting material on which a functional component, microchannel, microarray and the like, is formed or fabricated. Depending upon the application, by functional components it is intended electrically conductive elements that facilitate or enable the intended chemical operations. For example, functional components can be electrodes for manipulating charged entities, heaters, electrochemical detectors, valves, sensors for temperature, pH, fluid flow, and the like. By strongly adhered, it is meant that the component is capable of withstanding conventional peel tests.

The substrates of the provided devices can be produced using norbornene-based monomer molecules polymerized through a ring opening metathesis polymerization (ROMP) followed by hydrogenation. The polymers are substantially completely hydrocarbon, will generally have less than about 5% unsaturation (based on the number of double bonds present prior to hydrogenation), and have heat resistance, having a Tg of greater than about 60° C., usually greater than about 90° C. Comonomers include substituted norbornene modified monomers, particularly alkyl substituted norbornenes and polycyclics, 1-olefins of from about 2 to 10 carbon atoms, etc.

By norbornene based polymers is intended that the polymer comprise at least about 10 mole % of a norbornene monomer, particularly where the polymer is formed by polymerization using ring opening metathesis polymerization (ROMP), followed by hydrogenation to reduce available unsaturation. Desirably, the norbornene based polymer will consist of monomers comprising norbornene and substituted norbornenes.

The norbornene monomer will usually be at least about 20 mole %, more usually at least about 50 mole %, frequently at least about 75 mole %, of the copolymers. The intrinsic viscosity of the polymers will be at least about 0.5 dl/g (as determined in toluene at 25° C.). The polymers can be prepared in conventional ways, a number of homo- and copolymers being commercially available. See, for example, U.S. Pat. No. 5,191,026. Conveniently, the polymers employed by the provided devices are produced by ring opening metathesis (ROMP) of norbornene or norbornene derivatives. The metathesis reactions are known in the art, examples of which are provided in U.S. Pat. Nos. 4,945,135; 5,198,511; 5,312,940; and 5,342,909. After polymerization, the double bonds of the main polymer chains and the substituents are substantially saturated through hydrogenation. See Hashimoto, M., Synthesis and Properties of Hydrogenated Ring Opening Metathesis Polymer, Polymeric Materials: Science and Engineering, American Chemical Society, Vol. 76, pg. 61.

The preferred subject substrate material is amorphous, water insoluble, non-porous, nonpolar (electrically neutral) and electrically non-conductive, i.e. has a high electrical resistance. The material is stable having sufficient mechanical strength and rigidity to retain its shape under the conditions required for chemical operations. For instance, capillary electrophoresis often requires the use of a salt containing aqueous media in which the pH may range from 2 to 12. The polymers are thermoplastic and suitable for precision forming or shaping using conventional molding and extrusion processes. Web based film processing is also possible where the subject polymer is extruded into a substrate form. See, for example, PCT/US98/21869. The films prepared will generally have a thickness in the range of about 25μ to 1000μ, more usually in the range of about 25μ to about 750μ.

For the most part, the substrate material comprises one or more different monomers, wherein individual monomeric units along the chain may vary, depending upon whether the polymer is a homo- or copolymer, where the polymer will comprise at least about 50 mole % of monomers of the formula:

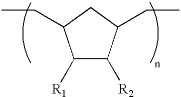

wherein R₁ and R₂ are hydrogen, alkyl of from 1 to 12, usually 1 to 6 carbon atoms or are taken together to form a ring with the carbon atoms to which they are attached, where the ring structure may be mono- or polycyclic, and will have including the carbon atoms to which they are attached, from about 5 to 12, usually from about 5 to 10 carbon atoms, and may be substituted or unsubstituted, particularly from 1 to 2 alkyl substituents of from about 1 to 6 carbon atoms.

Of particular interest are copolymers based on norbornene and, at least one of dicyclopentadiene (DCP), tetracyclododecene (TCD), 4,7-methano-2,3,3a,4,7,7a-hexahydroindene (HDCP) or dihydrodicyclopentadiene, 1,4-methano-1,4,4a,9a-tetrahydrofluorene (MTF), and the alkyl substituted derivatives thereof, particularly having from 0-2 alkyl groups of from 1 to 6, usually 1 to 3 carbon atoms.

The desired properties and overall qualities of the polymers employed for the substrates can be manipulated through variations in the selection and ratio of the monomeric units. See Hashimoto, M., Synthesis and Properties of Hydrogenated Ring Opening Metathesis Polymer, Polymeric Materials: Science and Engineering, American Chemical Society, Vol. 76, pg. 61. Accordingly, the subject polymers will have good solvent resistance to organic solvents, light transmittance at a thickness of 3 mm (ASTM D1003) of greater than about 90% at 350 nm and above, low water absorption of <0.01 (ASTM D570); low autofluorescence, usually less than 30%, more usually less than about 20% of the lowest signal to be detected using the subject device; compatibility with conventional chemical reagents and media, with low adsorption of the media; will be wettable by aqueous salt solutions under the conditions of electrophoresis; and capable of molding and extrusion with retention of features that are introduced. For fabrication and use, it is also desirable to have a device which has a resistance to heat. Commercially available versions of the subject (co)polymers include the Zeonor® and Zeonex® polymer series from Nippon Zeon; the Accord® polymers from B F Goodrich; the Topas® polymers from Ticona; and the Arton® polymers from JSR. For a description of some of these polymers, see for example, Schut, J. H., New Cyclic Olefins are Clearly Worth a Look, Plastic Technology, Vol. 46, No.3, March 2000, pg. 44.

As mentioned above, functional components integrated into the provided devices include heating elements, electrodes, electrochemical detectors, sensors for pH, temperature, fluid flow, and the like. These components can be used to induce and control movement of fluids through the application of an electrical potential or current, control temperatures within localized areas of the device, enable electrochemical detection, control hybridization or binding of entities, conduct mixing of fluids, monitor flow, and the like. For determination of specific design and composition, it should be understood by those skilled in the art that the components must be electrically conductive. By electrically conductive, it is meant that these components are capable of conducting more than trivial amounts of electricity. The electrical resistance may be high or low, depending on many factors including electrical properties of the component's composition as well as its dimensions. For ordinary electrical conductors, low resistance is generally preferred. For resistors, higher resistances are usually desired. The resistance should not be so high, however, that for practical purposes they are not significantly conductive, as would be understood by those skilled in the art. From conventional equations 1 and 2 below, it is readily apparent that the design parameters of the components, i.e. width, shape, composition and thickness, are dependent upon desired resistance and conductivity.

V=IR where V is applied voltage, I is the generated current, and R is overall resistance. Equation 1

R=ρ*L/A where R is overall resistance, ρ is resistivity of the conductive material, L is the length of the component and A is its cross sectional area. Equation 2

Accordingly, the relative dimensions of the components will be determined by their intended function, i.e. a component that generates heat will generally have a higher resistance and a component that provides a voltage gradient from a specific power supply will usually have a lower resistance.

Conveniently, the subject components will be provided as a film or layer strongly adhered to the surface of the substrate. The thickness of this film will generally be in the range of about 1000 Å-4000 Å, more usually about 1500 Å to 3500 Å, usually about 2000 Å-3000 Å. The width of the film will be optimized according to relative design limitations. For instance, the greater the width of the component, the more susceptible it is to delamination. On the other hand, a narrower film inherently generates a higher resistance. Accordingly, the width of the subject components will usually be in the general range of about 0.001 μm to 0.4 μm. The length of the component is similarly determined by various design factors such as the required absence or presence of heat, the required voltages or currents, and the composition of the components.

Electrically conductive components can be comprised of a variety of materials. For example, in one embodiment the components are comprised of a metal, preferably a stable and unreactive noble metal where the component is exposed to relevant chemical reagents or samples, for example, where the component is a sensor for pH measurements or electrochemical detection. In another embodiment, the functional components are comprised of an electrically.conductive ink, such as an ink containing conductive metals or graphite. Such inks are well known in the art. See, for example, U.S. Pat. No. 5,047,283 and its cited references for a general description of electrically conductive inks printed on polymer surfaces, each of which is incorporated herein by reference. The viscosity of the electrically conducting ink can vary widely. For example, the viscosity of the electrically conducting ink can provide for flow-, paste-, or solid-like properties. In yet another embodiment, the components can consist of an epoxy resin comprising an electrically conductive portion, usually metal.

In addition to functional components, the provided devices will preferably incorporate conductive leads connected to the subject functional components. This enables the delivery of a power source to the component as in the cases of heaters or electrodes for driving charged entities, and the delivery of a signal from the component to relevant monitoring equipment, such as in the case of a sensor for monitoring pH, electrochemistry, temperature, flow, and the like. These leads are subject to the same design parameters and limitations to the functional components as referenced above. Preferably, thin film connections are utilized from the edge of the chip. This facilitates electrical connection of the device with automated electronics, for example a computer processor for operating the device, i.e. administering current, monitoring conditions within the device, and the like. An example of such a lead connection in a microfluidic device is described in U.S. Pat. No. 5,906,723 which is incorporated herein by reference. Another benefit of using a thin film connection readily becomes apparent with the manufacture of a multi-layered device where leads to the component that are interposed between two layers can interfere with the bonding or sealing of a laminate device.

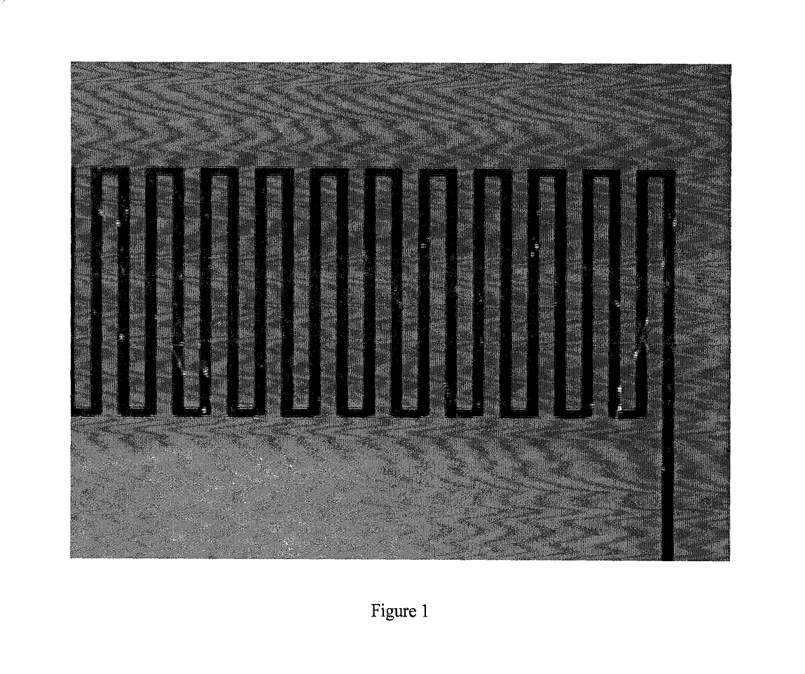

In one embodiment, the leads to the functional components can consist of wires directly connected to the device. Preferably such a connection is accomplished through soldering or other known methods for keeping two conductive surfaces in contact with each other. In another embodiment, such as that illustrated in FIG. 1, the lead(s) 100 can be integral to the component 101 itself comprised of a single film patterned into relevant functional regions.

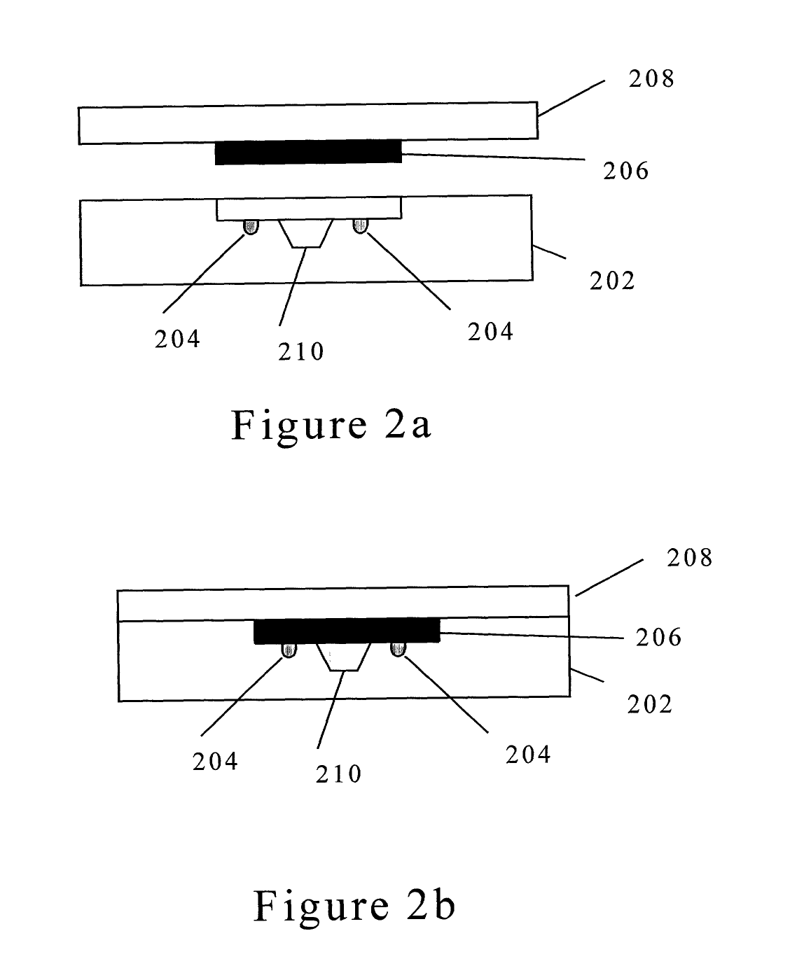

In another embodiment, the leads can be comprised of an electrically conductive fluid. Depending upon the application, such a fluid can be electrically conductive, thermally conductive or both thermally and electrically conductive. With reference to FIGS. 2a and 2b, electrical connection to the functional component can be accomplished through the use of microchannel networks filled with the conductive fluid 204 and in fluid connection with the component 206. The dimensions of the microchannels are in accordance with the required design parameters of the leads. One variation on this approach would be that in which the electrically conductive fluid comprises the functional component itself, for instance, a serpentine channel that is filled with an electrically conductive fluid is an example of a working design for a heater element. Another variation would be to introduce a conductive fluid into the microchannels which will subsequently cure into a solid form that is stable and integral to the device. In the alternative, localized regions of the fluid can be selectively cured, i.e., photocurable fluids selectively exposed to UV light. Such designs may be particularly useful for the manufacturing of the provided devices, especially those that may be multidimensional or multi level. Curable conductive fluids would include epoxy resins and inks comprising an electrically conductive portion, usually metal or graphite. Other examples of electrically conductive fluids include uncured inks and ionic or electronic liquid conductors. For example, aqueous salt solutions and liquid metals are useful in the invention. Conveniently, liquid metals such as mercury can be used in order to avoid hydrolysis and the generation of gases from reduction and oxidation processes present at electrodes where ionic solutions are utilized. Such reactions can also be minimized through the use of ionic entities in nonaqueous solvent such as methanol and the like. Other approaches include tailoring the components and the conductive fluid, for example, coating electrodes with silver chloride in combination with the use of an aqueous solution of chloride ions as the conductive fluid.

Deposition of conductive leads and functional components on to the subject substrates can be accomplished through a variety of conventional methods including both chemical and physical methods. For a general discussion of metal deposition on polymer substrates, see Metallized Plastics I: Fundamental and Applied Aspects, Eds: K. L. Mittal and J. R. Susko, Plenum, 1989. Regardless of the approach used, strong adhesion of conductive films to a particular substrate is dependent upon the interaction between the particular film and the substrate surface. This interaction can take the form of physisorption (a strong physical bond: e. g., van der Waals forces), chemisorption (e. g., ligation of the metal to functional groups in the plastic), chemical reactions involving the formation of very strong covalent bonds between the plastic and metal, interdiffusion, mechanical interlocking, and combinations thereof. A chemical interaction is generally required for electroless deposition where binding requires that surface be functionalized with a ligand, such as an amine or acid group. For some plastic materials ligands such as these are intrinsic to the surface, and in other cases they need to be induced via surface processing (plasma, corona, chemical oxidation, etc.). See, for example, Martin et al., Analytical Chemistry, 1995, 67, 1920-1928. Physical modification of the plastic surface can also be used to enhance adhesion to a plastic substrate. See, for example, U.S. Pat. Nos. 6,099,939, 5,047,283, and US SIR No. H1807, each of which is incorporated herein by reference. These chemical and/or physical modifications however can be detrimental to the manufacture and operation of analytical devices, interfering with patterning lithography, bonding of polymer laminates, and creating chemically reactive substrates.

Given the native surfaces of the apparently neutral norbornene based substrates, it is unexpected that conductive metals deposited on the substrate surfaces exhibit characteristically strong adhesion, withstanding conventional peel tests. This has been demonstrated with deposition by sputter and vapor techniques as well as with electroless deposition. In all instances, surface modification of the norbornene based substrate is not necessary to achieve a strong adhesion.

Patterning of the components from the films is accomplished through conventional lithography. In the cases where conductive inks are the provided embodiment, the inks can be applied to the substrate through a variety of printing approaches including screen printing, ink jet applications, printing presses, and the like. Similarly, the ink can also be patterned through conventional lithography where needed. The subject substrates are uniquely suited to such an application in that they are highly resistant to processing conditions required for ink application. For a general description of printing electrically conductive inks on polymer surfaces, see U.S. Pat. No. 5,047,283 and its cited references, each of which is incorporated herein by reference. Because such printing generally requires a curing or bonding step at a high temperature, not all plastics should be processed in such a manner. Those plastics which do have the requisite heat resistance, e.g., polyimide, often exhibit autofluorescence or other properties that are detrimental to the intended operation of the device. For instance, an integrated device having a highly fluorescent substrate is not practical if the intended application of the device is analyzing fluorescently labeled polynucleotides. Such a substrate would exhibit background interference, hindering necessary optical detection. Not only do the substrates of the provided devices exhibit low fluorescence and a high resistance to heat, they also possess an overall combination of properties that make them uniquely suited for relevant processing and operation.

Accordingly, a heat-resistant substrate may be preferred in certain situations. For example, in high throughout production lines, ink may be applied in a continuous manner onto a thin plastic film supplied by a reel. The coated film may then be moved through a heat tunnel to facilitate curing of the ink. For fast curing, the temperature must be relatively high to ensure the ink will cure before the next step in the fabrication process.

In a preferred embodiment, the subject integrated device can be configured as a microfluidic lab chip comprising channels generally having microscale cross-sectional inner dimensions such that the independent dimensions are greater than about 1 μm and less than about 1000 μm. These independent cross sectional dimensions, i.e. width, depth or diameter depending on the particular nature of the channel, generally range from about 1 to 200 μm, usually from about 10 to 150 μm, more usually from about 20 to 100 μm with the total inner cross sectional area ranging from about 100 to 40,000 μm², usually from about 200 to 25,000 μm². The inner cross sectional shape of the channel may vary among a number of different configurations, including rectangular, square, rhombic, triangular or V-shaped, circular, semicircular, ellipsoid and the like.

The integrated components can be provided in a number of configurations. For instance, the microdevice can comprise a single layer or a laminate as in FIG. 2a where each layer can provide a functional aspect to the device. For example, one layer may serve as a first substrate 202 where the microchannels 210, 204 and other features, e.g. reservoirs, may be cut, embossed, molded, etc. The other layer(s) may be used as substrates 208 for incorporating the functional components, providing ports or wells, and for sealing the microchannels and other features of the first substrate. As shown in FIG. 2b, the layers are brought together in an orientation such that the integrated components and various features on all the layers can interact accordingly with the microchannel. Joining the individual layers may be accomplished by heating, adhesives, thermal bonding, ultrasonic welding or other conventional means. Commonly, the devices are prepared by molding a substrate with the individual features and components present in the substrate and then applying a cover layer to enclose the microchannels, where access to the reservoirs may be provided in the molding process, substrate or by the cover layer. In a variation to this design, the components can be integrated in an independent cover lid that seals the reservoirs or sample wells of the device and minimizes evaporation. In such a configuration, the components will generally consist of driving electrodes positioned such that they will be in fluid contact with the reservoirs.

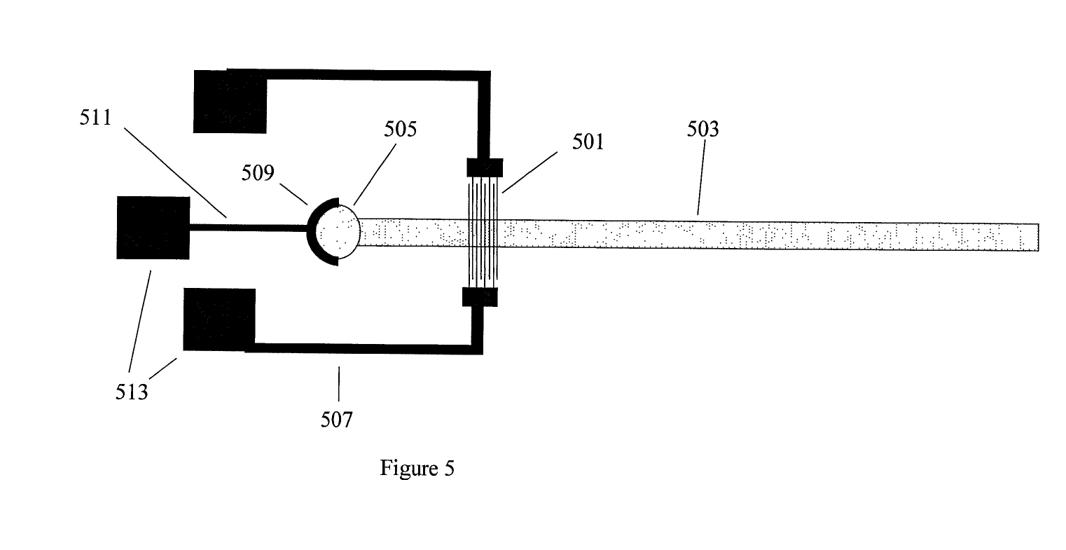

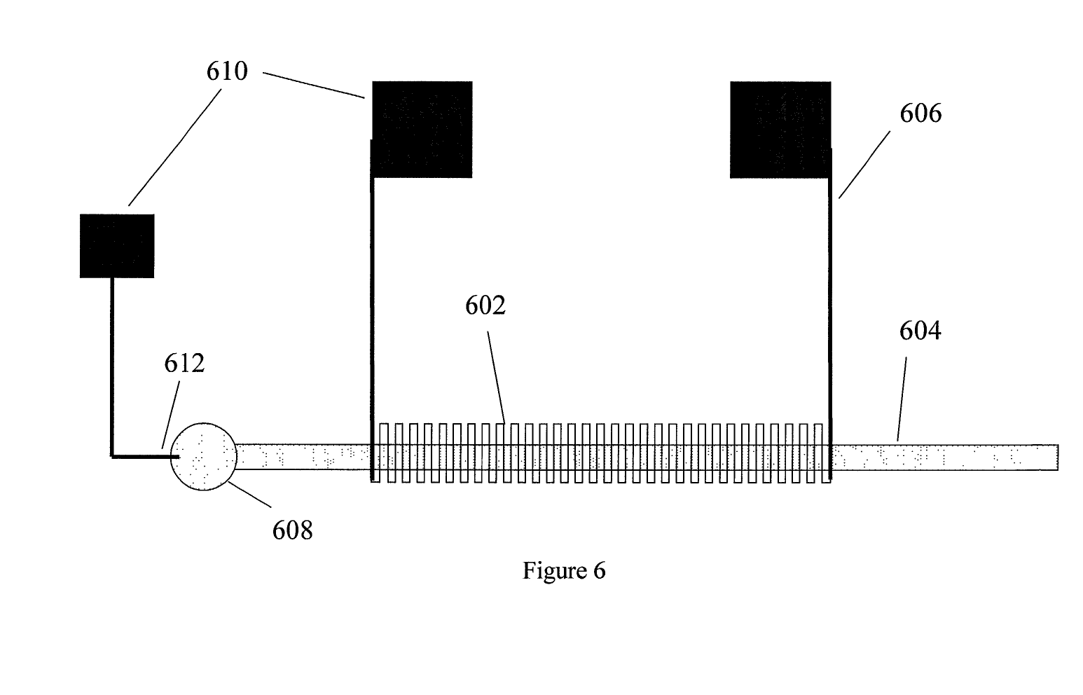

Placement of the components relative to the other microfeatures of the device is dependent upon the desired function of the component. For instance, where electrochemical detection is desired in an electrophoretic device, the positioning of the electrodes relative to a driving potential affect sensitivity and resolution. FIG. 5 shows one design for an electrochemical detector that demonstrates such a configuration. The detector is comprised of interdigitated detection elements 501, leads 507 and contacts 513. The detection elements 501 are located near the end of the capillary channel 503 for purposes of optimizing detection signals. For a general description of electrochemical detectors and their placement relative to electrophoretic channels, see U.S. Pat. No. 5,906,723 which is incorporated herein by reference. If the component is to serve as a driving electrode for controlling movement of fluids, the electrode should be placed in fluid connection with the channel 503, either directly or through a permeation layer, at opposite ends, alongside, or in localized regions of the channels. Preferably the electrode 509 is placed in a reservoir 505 located at the end of the channel 503. The driving electrode can be provided in a variety of shapes and dimensions, such as a half circle 509 or whole circle in fluid connection with the reservoir 505. Another configuration is shown in FIG. 6 where the driving electrode 612 is merely and extension of the lead, whereby hydrolysis is minimized by the smaller surface area of the provided electrode. For purposes of controlling temperature, the components can be configured as heaters placed within certain localized regions along the channel of interest. One design for such a heater includes a serpentine-like heater element 602, leads 606, and contacts for the power supply 610. Another heater design includes a heater element that is a solid band and variations or combinations in between. For monitoring flow, electrodes should be optimally positioned within the channel to ensure accuracy, e.g., downstream and immediately adjacent to the location of sample injection or around the detection zone. For general examples of microchannels, channel networks, microfluidic chips and their operation, see U.S. Pat. Nos. 5,750,015, 5,858,188, 5,599,432 and 5,942,443 and WO96/04547, each of which is incorporated herein by reference.

In another preferred embodiment of the claimed invention, the device can be configured as an electronic microarray device incorporating components for conducting hybridization assays. The components in this embodiment can comprise individually addressable sites for localizing reactions. For general examples of such devices, including structure and operation, see U.S. Pat. Nos. 5,605,662, 5,861,242, and 5,605,662, each of which is incorporated herein by reference.

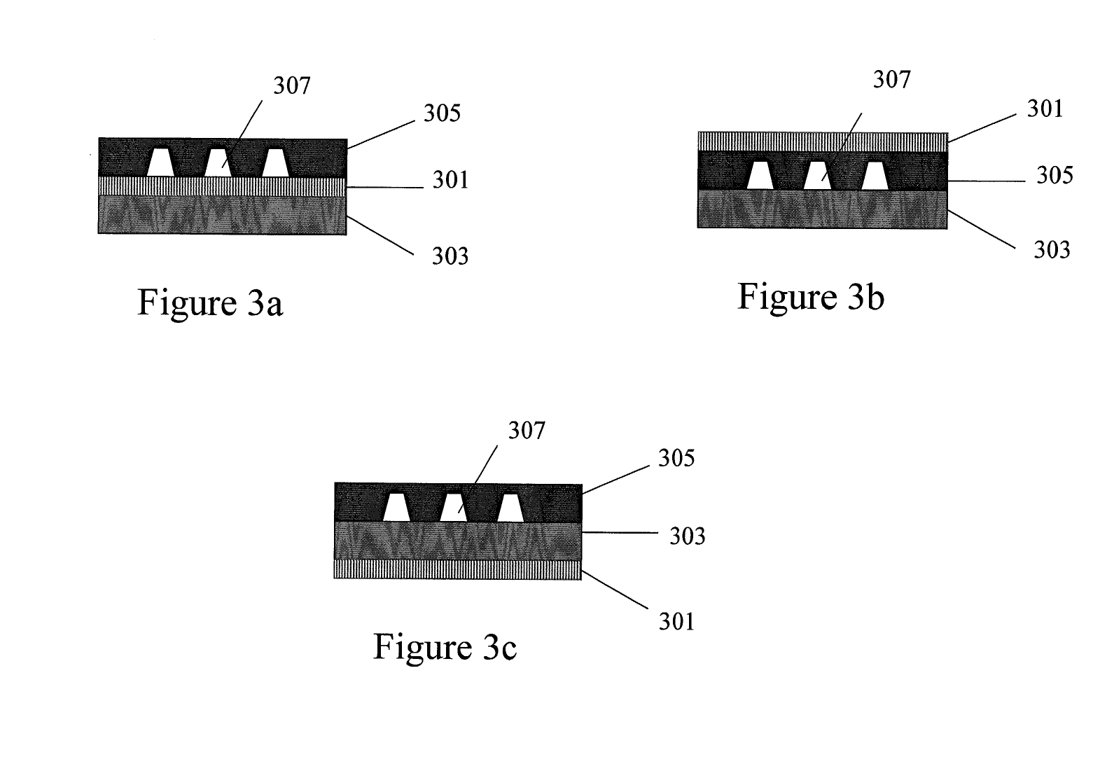

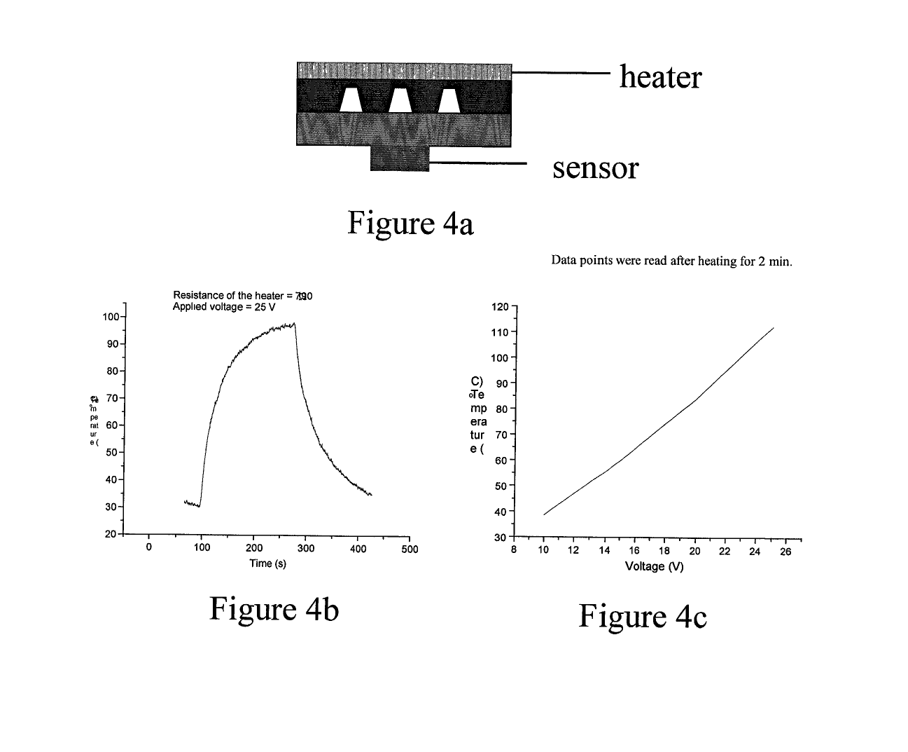

With reference to FIG. 1, a heater integrated on to the surface of a norbornene based substrate is shown whereby the heating element portion of the component is serpentine in shape and is of a length of about 230 mm. Its width is approximately 100 μm and its thickness is about 2000 Å. The heater is comprised of gold with a resistance of 790 Ω under an operating voltage of 25 V. The leads providing current to this heater are incorporated into the gold film, also having a thickness of about 2000 Å. Their width is also about 100 mm while their length is about 12 mm. The intended application of this particular heater design is to control the temperature in a microfluidic channel. Its general orientation is orthogonal to the particular length of a microchannel so as to heat the channel contents in a localized region of the device. With reference to FIG. 3a, 3b, and 3c, the component 301 can be provided on a cover film 303 that seals the channels 307, being in direct contact with the channel contents, it can be adhered to the opposite side of the channel substrate 305, or it can be provided on the exterior surface of the cover film. FIG. 4 illustrates one configuration of this device which can be used in a variety of applications such as thermocycling required for PCR and other variothermal operations. FIGS. 4b and 4c demonstrate actual data generated from the configuration.

### EXPERIMENTAL

Deposition of Conductive Films on Norbornene Based Substrates

Norbornene based substrates were prepared from Zeonor 1420R polymer. Cards with a thickness of 1.5 mm, were created by compressing 20 g of Zeonor resin between two 5.5″ electro-form mirrors at a temperature of 370° F.

The conventional peel test for checking adhesion of metallized films was used. This involved applying a piece of adhesive tape to the deposited metal and then pulling the tape off. If the tape came off without the adherent metal, then the deposited metal adhered well to the substrate surface and could be used for various applications.

### 1. ELECTROLESS DEPOSITION

Deposition of copper onto five norbornene based substrates was accomplished through three steps: activation, nucleation, and plating.

(a) Activation. A clean Zeonor substrate, not pretreated or etched in any special way prior to metallization, was immersed in 0.3 M SnCl₂+0.6 M HCl for 2 min, then thoroughly rinsed with D.I. water.

(b) Nucleation. The Sn²⁺-sensitized Zeonor card was exposed to solution of 10 mM PdCl₂+0.21 M HCl. Pd nanoparticles were formed with the Pd acting as both catalyst and nucleation site for the deposition of Cu during the plating step described below.

(c) Plating of Cu. The last step of the electroless deposition was the plating of Cu on the Zeonor surface which was modified with Pd nanoparticles. The composition of the Cu plating solution is shown in Table 1. The thickness of the deposited Cu layer was ˜0.2 μm after deposition for 7 min.

TABLE 1
The composition of aqueous Cu plating solution*

| Chemicals | g/L |
|---|---|
| CuSO₄.5H₂O | 5 |
| KNaC₄H₄O₆.4H₂O | 25 |
| NaOH | 7 |
| HCHO | 10 |

*The temperature for the plating was 20 ± 2° C.

In five out of five norbornene substrates independently metallized with copper through electroless deposition, the adhesion demonstrated was excellent, passing the “tape test” as defined above. Through subsequent displacement reactions with the metallized copper surface, silver, gold, palladium and platinum were deposited onto the norbornene based substrates.

### 2. DIRECT DEPOSITION OF GOLD ONTO SUBSTRATE SURFACE WITHOUT THE USE OF AN ADHESIVE LAYER

Vacuum deposition was carried out using the following procedure: Five norbornene based substrates were rinsed with distilled water prior to introduction into a vacuum chamber. After evacuation of the chamber, a layer of gold, 200 nm thick, was deposited on the substrates by e-beam deposition, at 1.5 nm/second. The substrates were then removed from the chamber for subsequent adhesion testing. In 80% of the metallized substrates, the adhesion demonstrated was excellent, passing the “tape test” as defined above.

Sputter deposition was carried out using the following procedure: Four sets of norbornene based substrates (5 substrates to each set) were rinsed with distilled water prior to introduction into a vacuum chamber. After evacuation of the chamber, each set was individually subjected for 30 seconds at 500 W to an argon plasma (10 torr), and then 200 nm of gold was deposited. The substrates were then removed from the chamber for subsequent adhesion testing. With all substrates, the adhesion demonstrated was excellent, passing the “tape test” as defined above.

### 3. PHOTOLITHOGRAPHY

Two photolithography procedures were performed including one procedure for features larger than 50 um and one procedure for features less than 50 um.

The procedure for preparation of features bigger than 50 μm on Zeonor included the following: (a) subsequent to deposition in the electroless manner above, a layer of Shipley 1818 was spin coated on the gold surface of the substrate at a speed of 4000 rpm for 40 seconds; photoresist was cured in an oven at 90° C. for 20 min.; (b) the photoresist was then exposed to a Hg Arc Lamp (500 W) for 20 seconds through a mask; (c) the photoresist was developed for 1 min. in a Shipley Microposit® developer; (d) Au was etched using Au (Gold Etch, Arch) etching solutions for respectively 1 min.; and (e) the remaining photoresist was then rinsed off with acetone leaving the desired pattern.

The procedure for preparation of features smaller than 50 μm included the following steps: (a) Subsequent to deposition from the electroless manner above, a layer of AZ P4620 photoresist was spin coated on the gold surface of the substrate at a speed of 4000 rpm for 80 seconds; photoresist was cured in an oven at 90° C. for 30 min.; (b) the photoresist was then exposed to a Hg Arc Lamp (500 W) for 40 seconds through a mask; (c) the photoresist was then developed for 4 min in a Shipley Microposit® developer; (d) Au was etched using Au (Gold Etch, Arch) etch solutions for 1 min; and (e) the remaining photoresist was rinsed off with acetone leaving the desired pattern. test

Using the methods described above, several types of masks can be used to pattern electrodes on the surfaces of norbornene based substrates. For features ≧500 μm, i.e. electrodes needed for a capillary electrophoresis power supply, a normal transparency can be used as a mask. For patterns with features smaller than 300 μm, a transparency film mask can be prepared from a high-resolution laser photoplotter. To pattern a feature with a very thin line width (≦20 μm), e.g., a heater element, a glass mask should be used for the patterning.

From the above results and discussion, many advantages of the claimed invention become readily apparent. The claimed invention provides for an integrated microdevice for analytical and research purposes comprised of a plastic material. This leads to many benefits such as low cost, numerous options for manufacturing processes, disposability, and the like. More particularly, the claimed invention provides for a substrate, suitable for chemical applications, that preferably has an unmodified natural surface to which conductive films are strongly adherent. This distinctive property is critical where surface chemistries present on the substrates of the device can interfere with sensitive chemical operations. For instance, where the device of interest involves channels for electrophoretic separations, complex surface chemistries of many conventional plastics and substrate materials are generally accompanied with variations in wall surface charge. These chemistries and surface charges tend to aggravate sample adsorption to the channel walls and generate non-uniform electroosmotic flow. Because adsorption results in skewed peaks and/or no analyte migration while non-uniform electroosmotic flow causes reduced separation resolution, reliable and consistent results using these modified surfaces become hard to obtain. The versatility and heat resistance of the norbornene based substrates also enables the integration of components comprised of electrically conducting ink into the subject devices.

All publications, patents and patent applications mentioned in this specification are incorporated herein by reference to the same extent as if each individual publication, patent, or patent application was specifically and individually indicated to be incorporated by reference.

The invention now being fully described, it will be apparent to one of ordinary skill in the art that many changes and modifications can be made thereto without departing from the spirit or scope of the appended claims.

What is claimed is:

1. An integrated microdevice for conducting chemical operations comprising:
a substrate comprised of a substantially saturated norbornene based polymer; and an electrically conductive film strongly adhered to said substrate wherein said film comprises a functional component integrated into said device.

2. The device of claim 1 further comprising electrical leads in connection with said component wherein said leads are comprised of microchannels containing an electrically conductive fluid.

3. The device of claim 2 wherein said conductive fluid is cured into a solid.

4. The device of claim 1 wherein said films are adhered to said substrate through electroless chemical deposition.

5. The device of claim 1 wherein said films are adhered to said substrate through physical deposition.

6. The device of claim 5 wherein said physical deposition is accomplished through vapor deposition.

7. The device of claim 5 wherein said physical deposition is accomplished through sputter deposition.

8. The device of claim 1 wherein said films are patterned on the surface of said substrate through lithography.

9. An integrated microdevice for conducting chemical operations comprising:
a plastic substrate comprised of a substantially saturated norbornene based polymer; and an electrically conductive ink adhered to said substrate wherein said ink comprises an integrated functional component.

10. The device of claim 9 wherein said ink is applied to said substrate through ink jet printing.

11. The device of claim 9 wherein said ink is applied to said substrate through screen printing.

12. The device of claim 9 wherein said ink is applied to said substrate through a printing press.

13. The device of claim 9 wherein said ink is patterned on the surface of said substrate through lithography.

14. A microfluidic device comprising:
a first substrate comprised of a substantially saturated norbornene based polymer; an electrically conductive film strongly adhered to said first substrate wherein said film comprises an integrated functional component; and
a second substrate having one or more microchannels disposed therein, said first and second substrates joined together wherein said microchannels are enclosed.

15. The device of claim 14 wherein microchannels are disposed in said first substrate.

16. The device of claim 14 further comprising a third substrate wherein said first substrate comprises a sealing layer interposed between said second and third substrates.

17. A microfluidic device comprising:
a first substrate comprised of a substantially saturated norbornene based polymer; an electrically conductive ink adhered to said first substrate wherein said ink comprises an integrated functional component; and
a second substrate having one or more microchannels disposed therein, said first and second substrates joined together wherein said microchannels are enclosed.

18. The device of claim 17 wherein microchannels are disposed in said first substrate.

19. The device of claim 17 further comprising a third substrate wherein said first substrate comprises a sealing layer interposed between said second and third substrates.

20. A microarray device adapted to receive a solution, comprising:
a substrate comprised of a substantially saturated norbornene based polymer; and
a plurality of selectively addressable components strongly adhered to said substrate, said components comprised of an electrically conductive film.

21. The device of claim 20 wherein said components are comprised of an electrically conductive ink.

22. An integrated microdevice for conducting chemical operations comprising:
a polymer substrate; and
an electrically conductive film strongly adhered to said substrate wherein said film comprises a functional component integrated into said device patterned through the use of a mask or stencil.
